(19) United States
(12) Patent Application Publication
(10) Pub. No.: US 2005/0114025 A1
(43) Pub. Date: May 26, 2005

(54) External control over aircrafts manoeuvres of aircrafts, maritime and motor vehicles and/or railway

(76) Inventors: Celso Sobrinho Brant, Brasilia (BR); Jonahas Gagliardi Madeira, Brasilia (BR)

Correspondence Address: STAAS & HALSEY LLP, SUITE 700, 1201 NEW YORK AVENUE, N.W., WASHINGTON, DC, 20005, US

(21) Appl. No.: 10/494,382

(22) PCT Filed: Aug. 31, 2002
(86) PCT No.: PCT/BR02/00146

(30) Foreign Application Priority Data
Oct. 31, 2001 (BR) PI0105209-8

(51) Int. Cl. G08G 1/16

(52) U.S. Cl. 701/301; 342/29

(57) ABSTRACT

A This invention patent is related to the External Control on aircrafts maneuver, maritime vehicles and motor or railway that contains a mechanism/system composed by a transceiver radio (A1) that will be installed in the object (A), that can be aircrafts, war ships, motor or railway, buildings, bridges, hydroelectric and nuclear power plants, dams, stadiums, mountains, which will have an antenna (A2) to transmit and receive electromagnetic signals, powered by an independent and autonomous module (A3), and will have an information and monitoring system (A4) to identify any approaching object (V) to the monitored object (A) as soon as it invades or get close to the limits predetermined on a defined place and perimeter.

The transceiver radio/antenna (V1) of the vehicle (V) transmits an eletromagnetic signal to central computer and change of course command (V2) that overrides the manual commands and/or automatic pilot and turn the elevator servo (V3) up and the servo of rudder (V4) right or left to change the aircraft position and direction (V) to bypass the object (A); it can also has a time limit to its action over the elevator servo (V3) and the rudder (V4), after which they will return to the normal condition, under the command of the required.

A This invention patent is related to the External Control on Aircrafts Maneuver, Maritime Vehicles and Motor or Railway. It is an independent/autonomous and auto defensive system, which is design to be used against terrorism or in accidents.

Nowadays, the vehicles do not have any mechanism against accidental or intentional collisions on specific objects, movable (airplanes, war ships, motor or railway) or static (buildings, bridges, hydroelectric and nuclear power plants, dams, stadiums, mountains).

Hence, these objects may be targets of huge destruction, even causing social-political and economical instability in National States.

To solve the problems above and obtain a mechanism or system interfering in the vehicle way, manned or not, to make it head off without internal primary commands, the External Control on aircrafts maneuver, maritime vehicles and motor or railway was created.

This gadget made of a joint system and mechanism is used to stop vehicles from maintaining the same way. It will be used to avoid collision with the target through commands which will overlap the primary ones, even though they are performed by humans or in an pre programmed way.

In order to make it easier to understand this gadget, a description of it will come next. The reference to the drawings enclosure is presented only as a demonstration. It is not intended to get the present patent protection with them. The basic list of components with its summarized function explanation is written as well.

Note: Figure with no scale or proportion.

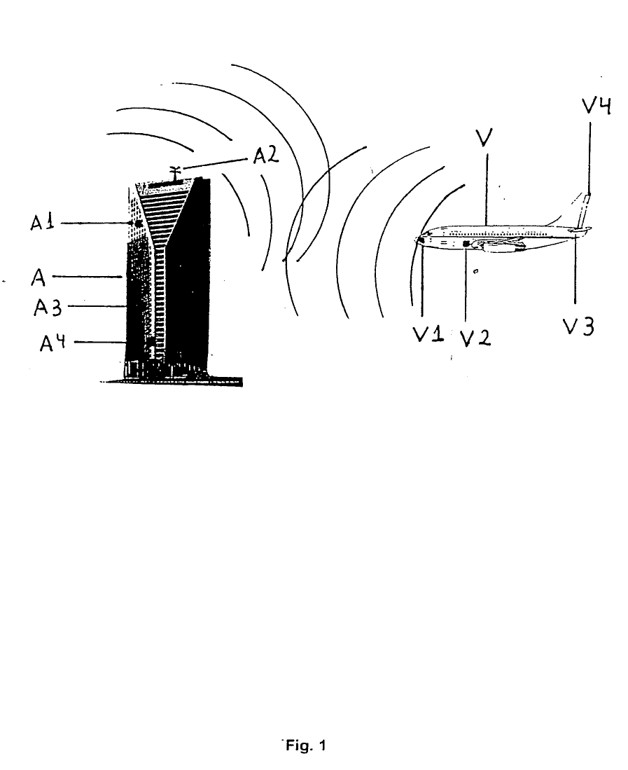

FIG. 1: Panoramic view of the external control and its mechanism/system.

Basic list of the mechanism/system components:
A1—transceiver radio, to be installed in the object (buildings, civil or military facilities and/or vehicles extremely strategic importance; social or cultural.
A2—antenna;
A3—power source system;
A4—Monitoring and information system;
V—vehicles (aircrafts, war ships, motor or railway vehicles);
V1—transceiver radio and antenna (system/mechanism responsible for the reception/analysis of the signal transmited by the transceiver radio (A1) when the vehicle (V) approaches the object (A), and calculation of the minimum perimeter where the automatic change of the vehicle (V) course will take place;
V2—Main computer station and change of course command;
V3—elevator servo and determiner of the way change;
V4—rudder and determiner of the way change.

The gadget contains, basically, a transceiver radio (A1) that will be installed in the object (A), which will have an antenna (A2) to transmit and receive electromagnetic signals, that will be encoded to make them unbreakable and not interceptable by external agents. The system will be powered by an independent and autonomous module (A3), and will have an information and monitoring system (A4) to identify any approaching object (V) and allow a defensive/offensive reaction against it as soon as it invades or get close to the limits predetermined on a defined place and perimeter.

The transceiver radio/antenna (V1) of the vehicle (V) is a joint system and mechanism with distance gauge equipment. This device is responsible for the analysis and reception of the signal that is sent by the antenna (A2) when the vehicle (V) approaches the object. When this process takes place, the computer activates the aircraft commands (V2) and turns the elevator servo (V3) up and the servo of rudder (V4) right or left to change the aircraft position and direction (V) to bypass the object (A).

This system/mechanism has also a way to work totally independent from the automatic pilot or the manual commands of the aircraft, which guarantees its activation and operation during the whole flight/trip. It can also has a time limit to its action over the commands listed above, after which they will return to the command of the pilot.

The system/mechanism has safety devices and alarms to prevent from changes or violation attempts to take place.

Once it can be easily noticed, this joint system mechanism offers o lot of advantages on the aerial, maritime or on land operations. There is no similar defensive method being used. It prevents targets from being hit. So, it provides the safeness and integrity of civil and military facilities.

The use of this joint system/mechanism will enable the creation of new security methods, and technologies. It will mainly give the safeness and tranquility to workers and users of the transportation systems mentioned above and also to those who live or work on buildings and civil or military facilities.

The joint system/mechanism has all the novelty, innovation, usefulness and industrial applicability. Therefore, it deserves the Patent privilege. It squares perfectly in all criteria required.

1a) EXTERNAL CONTROL ON AIRCRAFTS MANEUVER, MARITIME VEHICLES AND MOTOR OR RAILWAY, constituted basically by a transceiver radio (A1) that will be installed in the object (A), which will have an antenna (A2) to transmit and receive electromagnetic signs, powered by an independent and autonomous module (A3), and will have an information and monitoring system (A4) to identify any vehicle (V) that approaches the object (A) and invades the limits of a predetermined perimeter.

2a) EXTERNAL CONTROL ON AIRCRAFTS MANEUVER, MARITIME VEHICLES AND MOTOR OR RAILWAY, as stated on (1a), characterized by a system/mechanism composed by a transceiver and antenna (V1) of the vehicle, and a distance mesuring device responsible for the reception and analysis of the signal broadcasted through the antenna (A2) when the vehicle (V) approaches the object (A), making the central computer and control station to activate the aircraft commands (V2) and turns the elevator servo (V3) up and the rudder (V4) right or left, changing the aircraft position and direction (V) to bypass the object (A).

3a) EXTERNAL CONTROL ON AIRCRAFTS MANEUVER, MARITIME VEHICLES AND MOTOR OR RAILWAY, as stated on (1a) and (2a), also characterized by an operation tottally independent and autonomous from the automatic pilot of the aircraft and the manual controls performed by the pilot, which guarantees its activation and operation during the whole flight/trip, and that can also incorporate a time or angle restriction to the actuation of the elevator servo (V3) and the rudder (V4), that allows the pilot to recover the command of the aircraft; there are safety devices and alarms to prevent and detect any tentative of changes or violation attempts to take place.

4a) EXTERNAL CONTROL ON AIRCRAFTS MANEUVER, MARITIME VEHICLES AND MOTOR OR RAILWAY, as stated on (1a), (2a), and (3a), characterized by its applicability to trains, that will be equipped with a transceiver radio (A1) and antenna (A2) to transmit and receive eletromagnectic signals that will be received and analyzed by a joint distance measuring device and transceiver/antenna (V1) that will be installed in the trains; if they come to a situation of possible collision, that will be determined through the analysis of the electromagnetic signals of each train in the computer and command central (V2), a servo brake will be activated independent from the action of the engineer.

5a) EXTERNAL CONTROL ON AIRCRAFTS MANEUVER, MARITIME VEHICLES AND MOTOR OR RAILWAY, as stated on (1a), (2a); (3a) and (4a), characterized by its applicability to ships and boats, that will be equipped with a transceiver radio (A1) and antenna (A2) to transmit and receive eletromagnectic signals that will be received and analyzed by a joint distance measuring device and transceiver/antenna (V1) that will detect if they are in a collision route.
